(19) United States
(12) Patent Application Publication
(10) Pub. No.: US 2006/0221380 A1
(43) Pub. Date: Oct. 5, 2006

(54) System and method for distribution of network printer software

(76) Inventors: Jeff Pretz, Nampa, ID (US); Gloria Wickham, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/096,335

(22) Filed: Mar. 31, 2005

(51) Int. Cl. G06F 3/12

(52) U.S. Cl. 358/1.15; 358/1.1

(57) ABSTRACT

A system and method is provided for distribution of network printer software. The system includes a printer group designation configured to define a base definition for a group of client computers assigned to at least one physical printer. A printer name designation that is also linked to the printer group designation and each printer name designation can be associated with an individual physical printer. A printer profile is linked to the printer name designation. The printer profile may contain detailed printer profile information. A printer install script is linked to the printer profile. A user interface is configured to enable selection of the appropriate printer group designation. The user interface may then activate at least one corresponding printer install script.

### BACKGROUND

In order for a personal computer to be able to print documents and files, a workstation or computing device is electronically configured to be able to locate a printer and send messages to the printer. For a single computer configuration, there is often one printer that is directly connected to the computer using a USB (Universal Serial Bus) port or a parallel communication port. However, computer networks may have tens, hundreds or even thousands of printers, copiers, plotters and other printing devices attached to the network. There may also be tens, hundreds, or thousands of client computers connected to such large networks.

Periodically, a deployment of printers, copiers, and similar printing devices on a computer network may be undertaken. Such a deployment may be just a few new printers in a particular area or potentially hundreds of printers for a large roll-out across an entire business organization. When new printers or even re-arranged printers are deployed, the workstations or client computers attached to the network are likely to need installed printer drivers to communicate with the printers over the network. Printer drivers are a comparatively small piece of software used in the communication between a computing device's operating system (OS) and the printer hardware or firmware. Such printer drivers are generally configured with a network path and related information that corresponds to the printer's network configuration.

Printer drivers and software may also need to be configured for new or upgraded client computers when they are initially connected to the network. For example, driver loading and reconfiguration may need to take place when one or more new workstations or client computers are installed, even if the printing devices remain the same.

When a group of printers, copiers, personal computers, or other similar networked devices is rolled out onto the network, this generally means that one or more technical support individuals are scheduled to visit each individual workstation to install and configure printer drivers for each computer. The reason that relatively highly paid technicians are used for this process is because the installation process for drivers and printer path configuration is generally more complex than the average computer user is trained to perform. Even savvier computer users may not have knowledge of network printer mappings and other related configurations.

Because the printer technicians may visit each client computer or device at the rollout of printers, this invested time can result in a significant cost to a business. In addition, the wrong printer drivers may occasionally be installed by the technicians for a particular client computer because the technicians are not aware of which printers the user needs.

### BRIEF DESCRIPTION OF THE DRAWINGS

FIG. 1 is a block diagram of a system for distribution of network printer software in accordance with an embodiment;

FIG. 2 is a flow chart illustrating operations in an embodiment of a method for the selection and installation of network printer software;

FIG. 3 illustrates an embodiment of a user interface screen in a system for selection and installation of network printer software; and

FIG. 4 illustrates an embodiment of a method for setting up a system for installation of network printer software using a web interface and an installation database.

### DETAILED DESCRIPTION OF EXAMPLE EMBODIMENT(S)

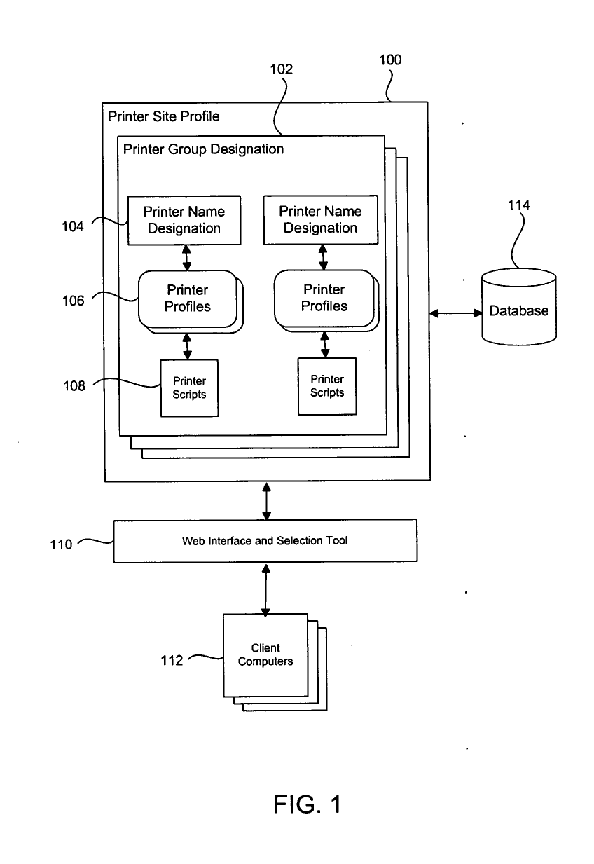

FIG. 1 illustrates an embodiment of a system for distribution of network printer software. The present system is designed to aid in rollouts and installations of printers or similar peripheral devices that communicate with a client or workstation computer over a computer network.

The system may include a printer site profile 100 that is configured to define a physical location with a plurality of printers and/or peripherals at the location. The printer site profile and related information can be stored in a networked database 114 or across multiple databases on a computer network.

The printer site profile 100 can contain more than one physical site designation within a local area network (LAN) or a wide area network (WAN). More specifically, the printer site profile can contain information defining the physical characteristics or location of the site being rolled out. The printer site profile may include a company's site location for a geographical location. For example, the printer site profile may be defined as the Hewlett-Packard Company in Palo Alto, California. Alternatively, the printer site may be the portion of a company campus such as Fort Collins North or Fort Collins South. A printer site may also define just a building within a company site, such as Building Alpha or Building Beta.

Two or more levels of printer site profiles may also be included as needed. One level may represent a geographic location (e.g., city or state) and the second level may represent a building or a site sub-division for the geographic location. For example, a site subdivision might cover multiple buildings, building sub-divisions, and similar designations.

A printer group designation 102 can be defined for the printer site profile. The printer group designation may define a grouping for a plurality of client computers 112 assigned to at least one physical printer. A building floor name, a cubicle row name, or a logical computer group can be assigned to one or more printing devices. In other words, groups of client computers within a network are generally assigned to use selected printers or printer groups based on the client computer's or personnel proximity or accessibility to the printers. Some companies may locate certain printers on a given floor and the printer group designation can represent the building floor. Other organizations may provide a printer for one or more rows or groups of office cubicles and the printer group designation can represent the row or group subdivision.

Additional workstation or client computer subdivisions can be used for the printer group designation as defined by the organizational or physical needs of the company or entity. For example, a printer group designation can include a building designator, a floor designator, a row designator, an aisle designator, a client group designator, or a cubicle designator. This means that a printer group designator can be created and it may have one or more printers associated with the printer group designator and/or a plurality of workstations that are known to use the printer group designation. The printers associated with the printer group designator will generally be configured based on the printer use in a physical area of a business. For instance, one row of cubicles may have their own ink jet printer but the laser printer for that group may be shared by two rows of cubicles. The present system supports such varying configurations.

The printers may be associated with the printer group designator based on security definitions, if desired. For example, only certain users may be authorized to access printer drivers for a color printer and thus a separate printer group designation can be created for a color printing group. In addition, the ability to load drivers for a secure printer that contains “check signature” fonts may be limited by password protecting a printer group designator.

Linked into each printer group designation 102 may be a plurality of printer name designations 104. Each printer name designation can be associated with an individual physical printer. This allows multiple printer designations to be contained within a printer group designation. An example of this structure could be a building floor where the users on the building floor have access to several printers such as a copier, a plotter and a color laser printer. Thus, a separate printer name designation for each of these printers can be contained within the printer group designation.

A printer profile 106 is linked to each of the printer name designations. The printer profile can contain detailed printer profile, configuration, setting, and preference information. Examples of this printer profile information can include printer location information, printer name, printer description, printer server share, and print server name. The printer profile may also store information for a copier, laser printer, ink jet printer, heat transfer printer, a plotter, multi-function printing device, and any other similar printing devices.

The printer profiles, printer name designations, and the printer group designations may also stored in a database 114. The database can be a relational database, a flat file, object oriented database, proprietary database, or a similar persistent storage system.

A printer install script 108 can be linked to the printer profile. This printer install script will generally be programmed in advance by technical personnel in order to install and configure the printer drivers and related software. The printer install script may contain programmed steps that can be executed on the client computers 112. For example, a CGI script, ActiveX component, Java component, or a similar install method can be used to install the desired printer drivers and to configure the drivers to enable end user printing.

A web interface 110 or user interface can be provided and may be configured to allow end user selection of the appropriate printer group designation and printer name designation for each end user's respective location. When the appropriate printer site, printer group designation, and printer names have been selected, then the user can activate the printer install script. Since the end user has provided a specific location of their workstation, the web interface can activate the corresponding printer install scripts.

The web page provided to the end user can employ a dynamic HTML link between the web interface for a user and the printer script file. Once the printer script file is activated, then the printer profile information can be loaded at install time. The printer profile information is then used to configure the installed printer driver and load properties and settings. For example, the printer path, printer duplexing, paper trays, paper types, ports, print queues, security, and similar printer device options can be configured using the printer script.

One embodiment can include utilities to add, modify, or remove printer profiles and installation scripts stored in the database. For example, a separate development editor can be provided for the system administrator to be able to enter the data structures and scripts described above with the proper printer and location relationships.

The present system and method is advantageous because the printer software is not pushed over to the client and installed in a generic format. If a generic configuration is installed for the client computer than a skilled technician must still come by at a later time and correctly configure the workstation. Because the end user specifies the spatial or geographic location of the end user's individual workstation, the system can install the printers with respect to the workstation location. In other words, end users understand where they are located in a building in common terms such as, “My workstation is located on the second floor in the west wing and I use a Laser Jet 4300 and Toshiba copier.” The present system allows end users to communicate with the installation system using designations that are understandable to the user such as a printer group designation defining the “2nd Floor-West”. These designations are then translated into appropriate printer installations based on user's workstation location and the printers to be used.

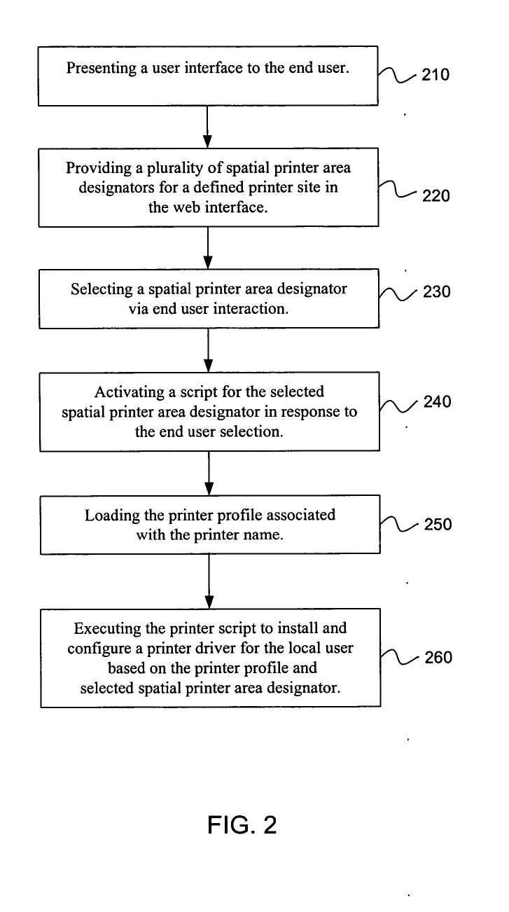

FIG. 2 illustrates a method for the distribution of network printer software as initiated by an end user. The method includes the operation of presenting a user interface, such as a web interface, to the end user, as in block 210. The web interface can be accessed through a web browser such as Microsoft Internet Explorer® or a similar web interface. Alternatively, a stand-alone network client interface maybe used that is installed onto the client computer.

A plurality of spatial printer area designators can be provided for a defined printer site through the user interface or web interface, as in block 220. The spatial printer area designators are defined names to which a number of workstations are assigned. For example, the spatial printer area designator can be “Building A-Floor 1.” A spatial printer designator can be generally compared to a printer group designator, where the spatial printer designator groups together printers that are used by physical use. Another operation in the method may include selecting a spatial printer area designator via an end user interaction, as in block 230. This means the user can select the designator that represents the workstation group to which the user belongs. The applicable spatial printer area designator can be selected from a plurality of spatial printer area designators in a drop-down interface list, a search window, or a similar user interface list.

Once the user has identified the user's workstation location and/or the printers associated with the spatial printer area designator, then a script for the selected spatial printer area designator can be activated in response to the end user selection, as in block 240. In response to the activation of the script, the printer profile associated with the printer name to be installed can be loaded, as in block 250. The data for the spatial printer area designator, printer names, and printer profiles may be loaded from a database. In addition, the spatial printer area designator may represent a building designator, a floor designator, a row designator, an aisle designator, a client group designator, a custom group of client computers, or cubicles.

The printer script can then be executed to install and configure a printer driver for the user's workstation based on the printer profile and selected spatial printer area designator, as in block 260. Configuration can include mapping a shared printer to a user's workstation computer using the network printer path defined for the network operating system. The printer profile may also include printer related information comprising the printer location, printer location designation name, printer description, printer server share, and print server name. This detailed printer profile information can be used to install or configure the printer's drivers. In addition, the printer drivers may be loaded and installed from a database or stored in a network storage device in file directories. The printer script or printer profile can have links that refer to the printer driver storage locations.

The selection of a spatial printer area designator may also include the operation of selecting a physical printer name. The selection of the physical printer name can be performed by the end user. Being able to select a physical printer name allows the user to select a specific printer for which they would like to have a printer driver loaded. This is valuable because a user may not want to load each of the multiple printer drivers that can be associated with a spatial printer area designator.

In one embodiment where multiple printers are associated with the spatial printer area designator, then multiple scripts may be sequentially executed. If a single printer is associated with the designator, then that single printer may be installed. Alternatively, the end user may be provided prompts or check boxes that are defaulted to selected status in order to allow an end user to select which printers associated with a spatial printer area designator should be installed.

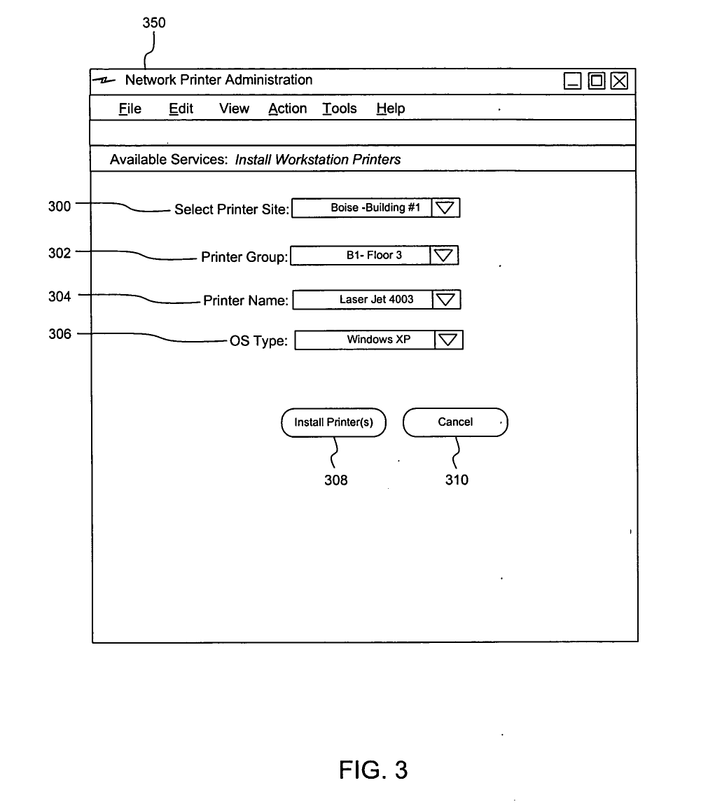

FIG. 3 illustrates an embodiment of a graphical interface window that may be used with the present system and method. The window may be network printer administration window 350 that can be accessed as a networked application through a web browser window, a stand-alone application, or the application can be interconnected into another network administration application. When the application is a web enabled application, this allows the application to be delivered through a web browser in a fast and efficient manner without using a trained system administrator's time to install the web application. If additional ActiveX or Java components need to be installed, then the components can be installed through the browser by the end user.

A user may select a printer site 300 where the user is located or to which the user belongs. A printer site can correspond to the site profile, and the printer site represents a high level printer grouping. For example, a printer site can represent a physical facility location in a city, a group of buildings or a single building. In the example of FIG. 3, it can be seen that building #1 in the city of Boise has been selected with the drop-down selection window.

A printer group 302 within the printer site can be selected through the web interface. The printer group represents one or more printers that are assigned to a plurality of end users' client computers in a pre-defined area. For example, a building might be divided by floors, divided into quadrants, or divided by other demarcation lines. Generally, users are assigned to printers that are in close physical proximity or are accessible to them.

Once a printer group has been selected then a specific printer name 304 may be selected. The specific printer name may include the make and model of the printer, the network name of the printer, and/or some indicator of the physical location of the printer (e.g., Building #1 West). In addition, the operating system type 306 can be selected because the printer drivers that will be installed may apply to a specific operating system (OS) version. Selection of a printer name and OS type may be optional in some embodiments.

Once the printer type, printer name, and printer group have been selected, then the install printer(s) button can be activated. The install button will load the printer install script which will in turn launch other processes. For example, the printer install script can start the printer driver install program and install programs for any associated printer services or applications. Once the install programs have been completed, the printer install script may load the printer profile information and configure the printer driver and properties to properly make the needed configuration for the given network. A cancel button 310 may also be provided in order to stop the installation procedure before it is completed or the cancel button may be configured to return to a previous page if no action is taking place.

Although a graphical user interface has been described here, other types of user interfaces can be used. For example, a text based user interface may be used. In addition, the user interface described here is generally used by the end user to avoid consuming the time of a technically skilled individual. However, the user interface may be for a managerial user who is not technically skilled but who is able to deploy new drivers to a group of workstations.

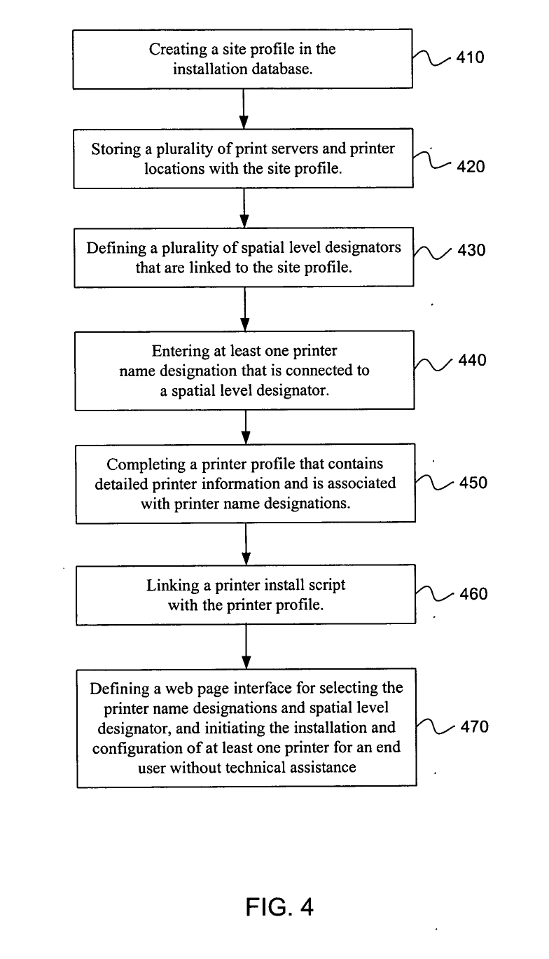

FIG. 4 illustrates an embodiment of a method of setting up the system for installation of network printer software using a web interface and installation database. The method can include the operation of creating a site profile in the installation database, as in block 410. The site profile can contain a site name and/or physical site location. The site profile can be entered into the database by an administrator and more than one site profile can be entered into the database. This allows the database to be used for an entire business enterprise. Multiple site profiles may also be related to each other hierarchically.

Another operation is storing a plurality of print servers and printer locations with the site profile, as in block 420. These printer servers and printer locations are network configuration paths, print queues, or actual printer addresses that the end users can send print jobs to. A plurality of spatial level designators can be defined that are linked to the site profile, as in block 430. For example, the spatial level designators can be a floor, a row of cubicles, or a similar cluster of workstations based on a logical relationship between the workstations and the printers. In general, there is at least one printer name designation that is connected to a spatial level designator, as in block 440. This means there is at least one physical printer name or printer name designation associated with a specific group of workstations.

Each physical printer name may have a printer profile that contains detailed printer information, and the printer profile may be associated with the printer name designations, as in block 450. The printer profile can contain detailed printer properties and configurations as described above.

In another operation, a printer install script may be linked with the printer profile as in block 460. This linking allows the printer script to retrieve the printer profile information and use the printer configuration information to set up the printer drivers appropriately.

A further operation that can be performed by a system administrator or developer is the defining of a web page interface to enable a user to select the spatial level designator, and similar indicators, as in block 470. The web page can be configured to initiate the install script(s) and configuration of at least one printer for an end user without technical assistance. The printer profiles, printer name designations, printer scripts and similar information can be stored in a local or networked database.

The present embodiment is advantageous because the present system and method enables the printer software to be a non-technical user without aid from a highly paid technical support person. Because the end user specifies the spatial or geographic location of the end user's individual workstation, the system can install the printers with respect to the spatial location, and then the system can configure the printer based on print mappings, print queues and printer preference as defined by the printer profile with respect to the logical designators. The end users understand where they are located at a business site in common terms and present embodiment allows end users to communicate with the installation system using designations that are understandable to the user. These designations may then be translated into appropriate printer installations.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for distribution of network printer software, comprising:
a printer group designation configured to define a base definition for a group of client computers assigned to at least one physical printer;
a printer name designation linked to the printer group designation, the printer name designation being associated with an individual physical printer;
a printer profile linked to the printer name designation, the printer profile containing detailed printer profile information;
a printer install script linked to the printer profile; and
a user interface configured to select the appropriate printer group designation and activate at least one corresponding printer install script.

2. A system as in claim 1, further comprising a printer site profile configured to define a location where a plurality of printers are located and the printer group designation is contained within the printer site profile.

3. A system as in claim 1, wherein the printer profile further includes printer information selected from the group consisting of printer location profile, printer location designation name, printer description, printer server share, and print server name.

4. A system as in claim 1, further comprising a dynamic HTML link between the user interface for a user and the printer install script in order to load printer profile information at install time.

5. A system as in claim 1, further comprising a printer removal tool configured to remove printer profiles stored in the database.

6. A system as in claim 1, wherein the printer profile can represent a copier, laser printer, ink jet printer, a plotter, and multi-function printing device.

7. A system as in claim 1, wherein the printer group designation can be selected from the group consisting of a building designator, a floor designator, a row designator, an aisle designator, a client group designator, and a cubicle designator.

8. A method for distribution of network printer software by an end user, comprising the steps of:
presenting a user interface to the end user;
providing a plurality of spatial printer area designators for a defined printer site in the user interface;
selecting a spatial printer area designator via end user interaction;
activating a printer script for the selected spatial printer area designator in response to the end user selection;
loading a printer profile associated with the spatial printer area designator and a printer name;
executing the printer script to install and configure a printer driver for the local user based on the selected spatial printer area designator and the printer profile.

9. A method as in claim 8, wherein the step of selecting a spatial printer area designator further comprises the step of selecting a physical printer name, wherein the end user selects the physical printer name.

10. A method as in claim 8, further comprising the step of loading the spatial printer area designator, printer name, and printer profile from a database.

11. A method as in claim 10, further comprising the step of loading the printer profile that includes printer information selected from the group consisting of printer location profile, printer location designation name, printer description, printer server share, and print server name.

12. A method as in claim 8, further comprising the step of loading the printer driver from a database.

13. A method as in claim 8, wherein the step of configuring the printer driver further comprises the step of mapping a shared printer for a user's client computer.

14. A method as in claim 8, wherein the spatial printer area designator can be a plurality of spatial printer areas designators.

15. A method as in claim 14, wherein the spatial printer area designator can be selected from the group consisting of a building designator, a floor designator, a row designator, an aisle designator, a client group designator, and a cubicle designator.

16. A method as in claim 8, wherein the user interface is a web interface.

17. A method for installation of network printer software using a web interface and installation database, comprising the steps of:
creating a site profile in the installation database;
storing a plurality of print servers and printer locations with the site profile;
setting a plurality of spatial level designators that are linked to the site profile;
entering at least one printer name designation that is connected to a spatial level designator;
completing a printer profile that contains detailed printer information, the printer profile being associated with the printer name designation;
linking a printer install script with the printer profile; and
defining a web page interface to enable a user to select the spatial level designator, which is configured to initiate the installation and configuration of at least one printer for an end user without technical assistance.

18. A method as in claim 17, further comprising the step of storing the printer profile and printer name designation in a database.

19. A method as in claim 17, further comprising the step of creating a site profile that has a name and physical site location information.

20. A system for installing and configuring network printer software, comprising:
a printer group means for storing a base definition for a group of client computers assigned to at least one physical printer;
a plurality of printer name designation means each configured for representing an individual physical printer, the printer name designation means being linked to the printer group means;
a printer profile means for containing detailed printer profile information, the printer profile being linked to each of the printer name designation;
a printer install means containing executable steps for installing printer drivers, the printer install means being linked to the printer profile; and
a web browser interface means for selecting the appropriate printer group designation and printer name designation and for activating the corresponding printer install script.

21. An article of manufacture including a computer usable medium having computer readable program code embodied therein for distribution of network printer software by an end user, comprising computer readable program code capable of performing the operations of:
presenting a web interface to the end user;
providing a plurality of spatial printer designators for a defined printer site in the web interface, wherein the spatial printer designators represent a plurality of printers assigned to use certain printers;
selecting a spatial printer area designator via end user interaction;
activating an install script for the selected spatial printer area designator in response to the end user selection;
loading a printer profile associated with a printer name as directed by the install script;
executing the printer script to install and configure a printer driver for the local user based on the spatial printer area designator selected.
